(19) United States
(12) Patent Application Publication
(10) Pub. No.: US 2017/0265454 A1
(43) Pub. Date: Sep. 21, 2017

(54) Molded Plastic Treestand

(71) Applicant: Jared Thomas Kramer, Clinton, PA (US)

(72) Inventor: Jared Thomas Kramer, Clinton, PA (US)

(21) Appl. No.: 15/069,986

(22) Filed: Mar. 15, 2016

(51) Int. Cl. A01M 31/02

(52) U.S. Cl. CPC A01M 31/02

(57) ABSTRACT

A portable treestand for hunters includes a one piece supporting platform, seat and post molded from a light weight thermoplastic material. The unitary construction of the platform and seat eliminates a large number of fabrication steps and related fastening techniques and devices used therewith. As a result, the platform and seat are stronger, lighter and more rigid, free from many potentially movable joints, and may be made with an irregular pattern.

### BACKGROUND

The present invention pertains to a portable treestand for hunting or the like and in particular, to a treestand in which the main supporting platform and seat are each constructed as one-piece and made of lightweight thermoplastic material.

Portable treestands for hunting, which are demountable to the trunk of a tree to provide an improved vantage point, have been used for many years. Such treestands are available in an extremely wide variety of types, providing a myriad of sizes, shapes, materials, mounting mechanisms and other features. Key among the important features to be considered by a hunter in choosing a treestand are safety, weight, simplicity of construction and use. The considerations of safety and weight are often conflicting because adequate strength frequently requires the use of heavier and stronger structural members. Lightweight structural materials are, therefore, used almost exclusively in the construction of treestands. To balance the considerations of strength, weight and cost, structural aluminum has been the material of choice. As a result, the majority of treestands on the market today utilize some type of tubular aluminum structure for the main support platform of the treestand. The aluminum structure may include cross members which are closely spaced to provide a platform on which the hunter may stand directly. More often, however, the aluminum framework generally defines the outer perimeter of the platform and includes a few intermediate cross members. The supporting framework is covered with a thin rigid layer of floor material of any of several types, including sheets of wood or plastic and expanded metal grids.

In each of the prior treestand platforms, the platform and seat are fabricated from a plurality of components using a variety of fastening techniques, including welding, rivets, screws and bolts. Even in those treestand platform constructions in which the structural aluminum members are closely spaced so that a separate floor covering is not required, a large amount of welding is needed in the fabrication process. Where a floor cover or plate is also required, additional welding or the use of other types of fasteners must be undertaken.

It is also well known that welds occasionally break and that the welding process itself may have an adverse affect on the strength or structural integrity of the members as a result of high welding heat. The use of mechanical fasteners in the fabrication of a platform creates joints which inherently are not completely rigid and as a result may move and squeak or create other noises. Skilled hunters are extremely sensitive to any equipment that is unnecessarily noisy. Fasteners and fastener joints also present the potential for catching clothing or the like which is both annoying and potentially dangerous.

Thus, despite the extremely wide variety of treestands on the market today, all are subject to the same problems and deficiencies in construction, operation and use described above. It would be most desirable, therefore, to have a treestand which is of simple construction, does not require welded fabrication or the use of fasteners, and yet is strong and light weight. In addition, the treestand should be readily adaptable for use in both climbing and non-climbing applications. Finally, a treestand which would eliminate the need for the attachment of climbing stick holders would be most attractive.

### BRIEF SUMMARY OF THE INVENTION

In accordance with the present invention, a portable treestand includes a supporting platform of one piece, rigid construction having an open grate-like pattern. The unitary rigid one piece construction of the platform may be implemented in a form which eliminates virtually every problem characteristic of prior art fabricated platforms.

The platform, seat and post are preferably made as a plastic molding.

The platform includes a series of openings extending along the outer edge of the platform, remote from the tree's trunk to which it is attached, which are sized to receive and support the attachment mechanism of a series of climbing sticks. The openings are preferably sized and shaped to accept the attachment point (where their straps connect to their vertical stem while connecting to a tree trunk) of the climbing sticks.

### BRIEF DESCRIPTION OF THE DRAWINGS

FIG. 1 is a perspective view of a treestand of the present invention.

FIG. 2 is a top plan view of the main supporting platform of the treestand, utilizing the unique one piece molded construction and showing the open grate like configuration.

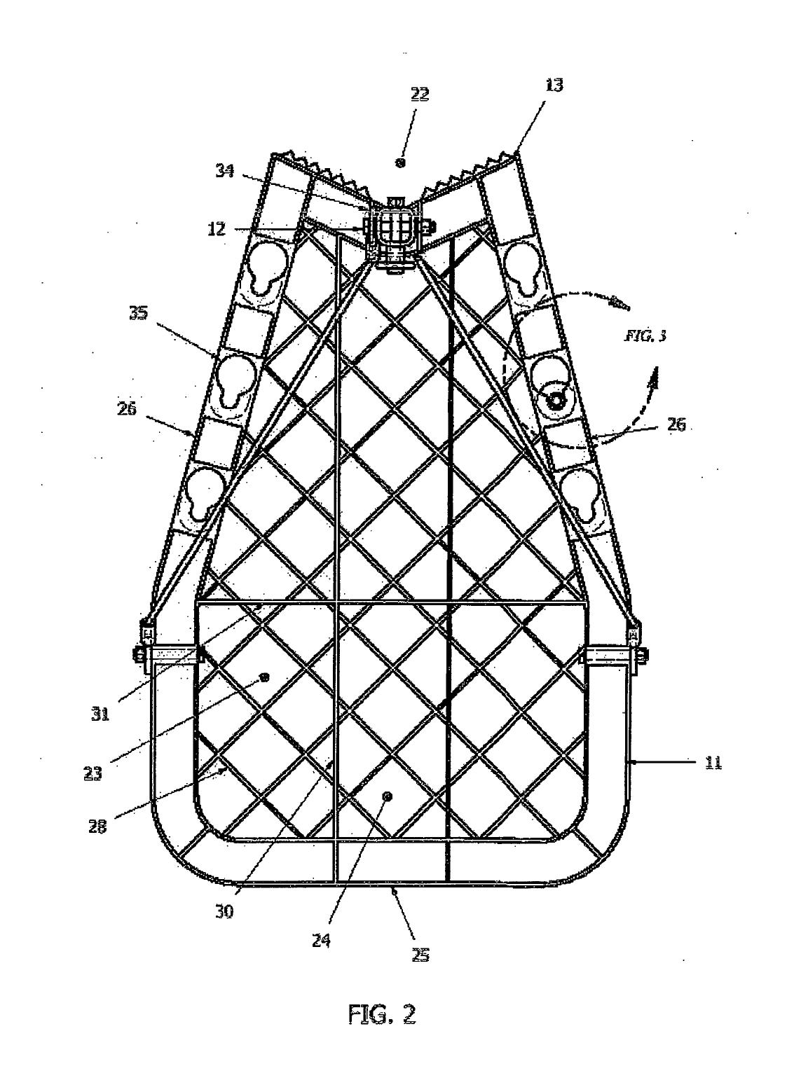

FIG. 3 is detailed view of a section of FIG. 2

FIG. 4 is a detailed perspective of a portion of the treestand platform showing its utility for attaching climbing sticks.

### DETAILED DESCRIPTION OF THE PREFERRED EMBODIMENT

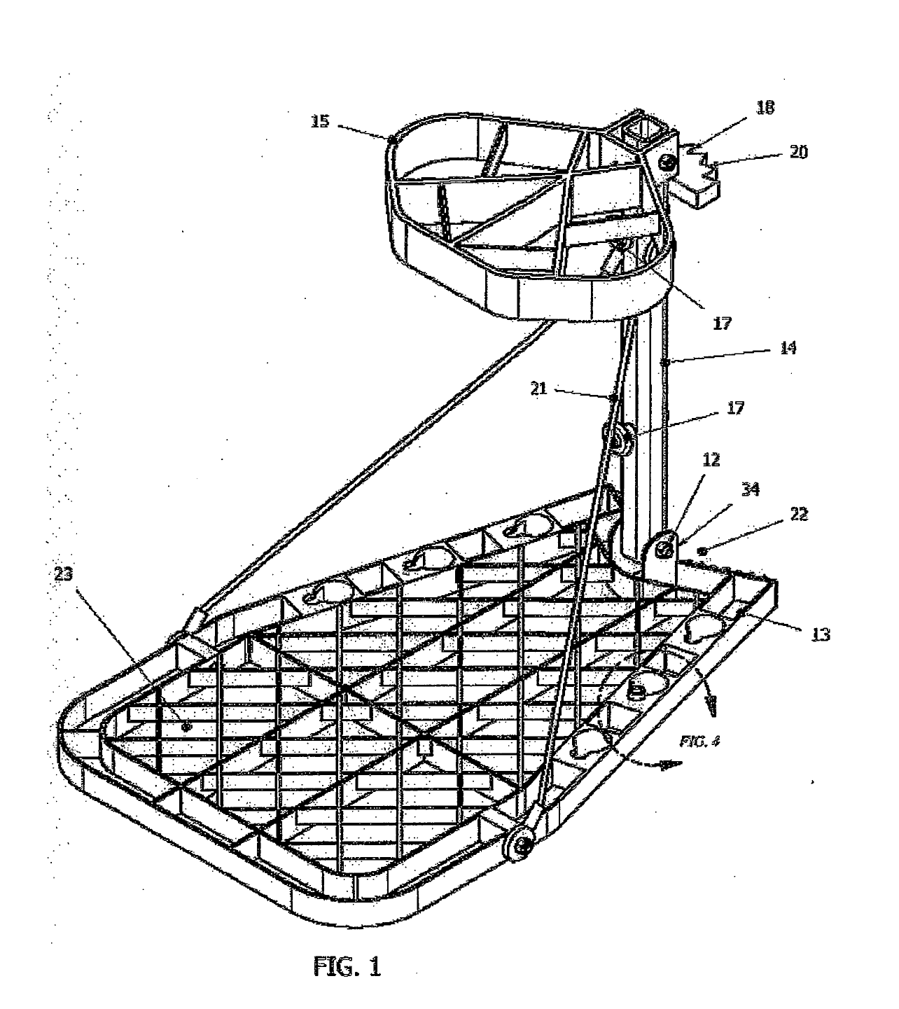

Referring to FIG. 1, the treestand 10 of the present invention includes a unique supporting platform 11 of uniform, one piece molded plastic construction. The platform may be used in a wide variety of treestand constructions. The treestand 10 shown in FIG. 1 is a non-climbing type, but the platform 11 is adaptable for use in so called “climbing” treestands which may be moved, by the action of the hunter standing or sitting thereon, upwardly along the trunk of a tree to a final desired position.

The platform 11 of the treestand 10 is attached adjacent to its inner edge 13 by a lower hinged connection 12 to a rigid center post 14. A seat 15 is attached by upper hinged connection 16 to the upper end of the center post 14. The seat 15 may be similar to the platform 11, but of a substantially smaller size, and comprised of a one piece molded plastic construction.

The primary mounting attachment for the treestand consists of two attachment knobs 17 connected to the center post 14. These knobs are to hold the ends of ratchet straps that extend around the tree trunk then attach back to the same knob. This happens at both of the attachment knobs 17. The treestand cleat 18 includes a reverse V-shape that engages the trunk of a tree to aid in setting up in a crooked tree. The downward pivotal movement of the main supporting platform 11 from an initial vertical position against the tree trunk, causes the center post 14 to move outwardly from the tree trunk, puts the ratchet straps in tension, and causes the teeth in the V-shaped notch 20 to bite into the tree. The main supporting platform 11 is maintained in a generally horizontal position with a pair of supporting cables 21 each of which is connected by its upper end to the center post 14 just below the upper hinged connection 16 and by its lower end to the lateral edge of the platform at a point outward from the tree trunk. The inner edge 13 of the platform is provided with a large V-shaped notch 22 which is also provided with teeth on its tree-engaging face to help hold the treestand securely in position once the ratchet straps have been securely locked around the tree trunk.

The overall pattern 23 resulting from the positioning of the interior members 28 defines a plurality of openings 24, most of which are generally small enough to provide adequate support for a hunter standing thereon. The pattern of openings 24 is preferably symmetrical with respect to a center post 14.

Another significant advantage of the unitary molded construction of the platform 11 is that all features necessary to accommodate attachment or connection to the other components of the treestand may be molded integrally into the platform, thereby avoiding fabricated assembly or attachment of additional pieces. Likewise, accessory features may also be included in the integral molding, as will be described hereinafter. For example, the lugs 34 on the inner edge 13 to accommodate the pin for the lower hinged connection 12 are integrally molded into the platform. As indicated, the inclusion of all necessary integral attachments and any auxiliary attachments may be made without utilizing supplemental welding, mechanical fasteners, or any other fabrication techniques or devices, all of which would otherwise add to assembly time and cost, create joints which may potentially weaken the structure, and introduce movable joints which may result in undesirable noises.

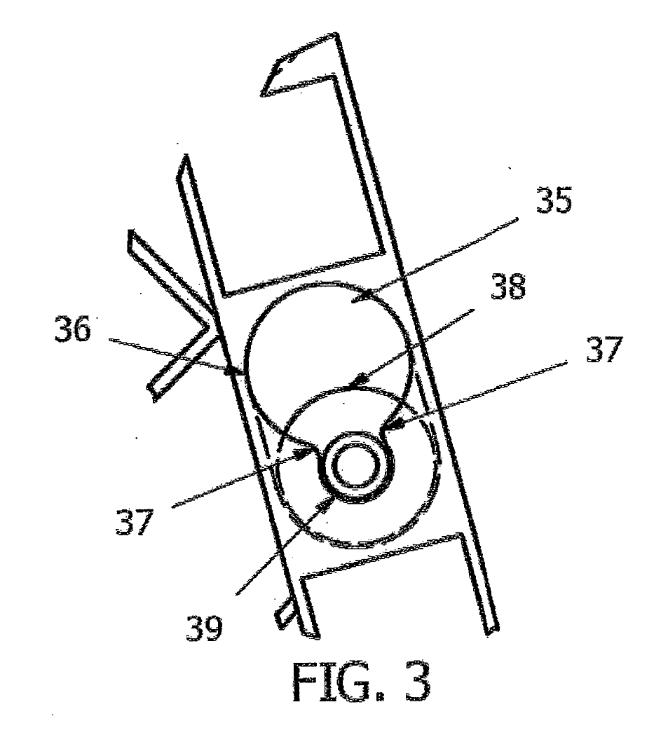

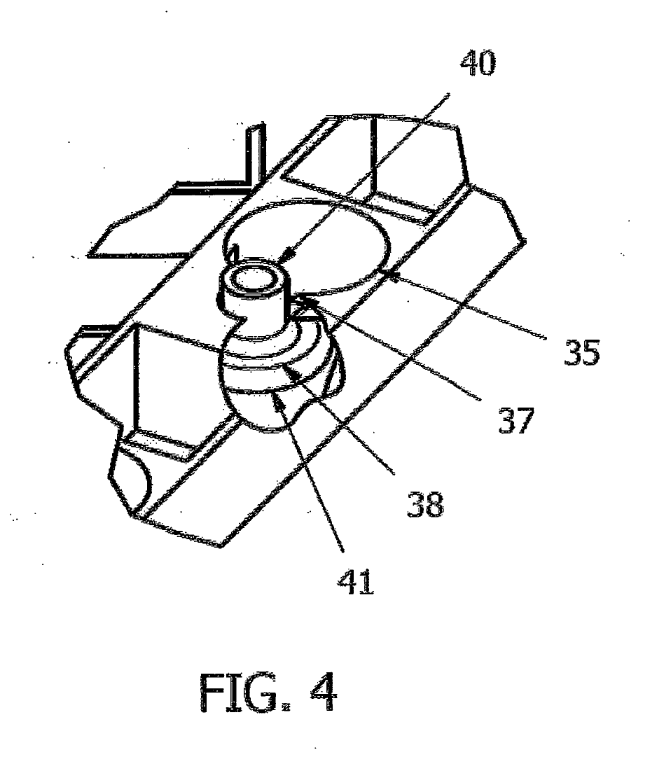

As shown in FIG. 3 and 4, certain openings 35 in the platform may be utilized, without any adaptation or auxiliary attaching device, to support and store climbing sticks. Again, no separate climbing stick attachment device is required. The openings 35 contain a large hole 36 for the climbing sticks ratchet strap attachment knob 38 to enter the body of the main supporting platform 11. Once in body of the main supporting platform 11 the climbing sticks will be pulled so that their ratchet strap attachment knob 38 slides passed two rounded edges 37 which create a detent that holds the ratchet strap attachment knob 38 in place. Once passed the rounded edges 37 the ratchet strap attachment knob 38 will be held in a smaller opening 39 that is larger than the neck 40 of the ratchet strap attachment knob 38, but smaller than the head 41 thus entrapping the climbing stick from easily falling out during transport or storage.

The inherent strength increase using a solid unitary molded plastic construction allows the size of the interior members 28 to be reduced, as well as their spacing. The solid plastic construction also reduces the transmission of noise more common in constructions utilizing hollow tubular structural members.

Various modes of carrying out the present invention are contemplated as being within the scope of the following claims particularly pointing out and distinctly claiming the subject matter which is regarded as the invention

What is claimed is:

1. The invention claimed is a portable treestand for demountable attachment to the trunk of a tree, said treestand comprising:
a main supporting platform made of molded thermoplastic;
said platform adapted to be attached at an inner platform edge to the tree trunk, and to extend generally horizontally outward from the trunk to an outer platform edge;
said platform being of uniform, one piece rigid molded construction having an open grate configuration;
and, attachment knobs connected to said platform for attaching said platform to the tree.

2. The invention claimed as set forth in claim 1 wherein the underside of the platform is flat and free of any structure depending downwardly there from.

3. The invention claimed as set forth in claim 1 wherein open grate configuration includes a series of openings adjacent to the edges of said platform;
said series of openings are to receive the ratchet strap attachment knobs from climbing sticks;
the attachment knobs of the climbing sticks are what the ratchet straps hook to when they are wrapped around a tree trunk when trying to hang a climbing stick onto a tree;
the openings adjacent to the edges of the platform will be a key shaped hole to receive the rounded knob of the climbing sticks;
each opening will have a circular hole slightly larger in diameter than the head of the climbing stick attachment knob;
at one quadrant of the circular hole there will be a slot that is formed to thus make the opening look like a key shaped hole;
where the hole meets the slot the platform will be made such that the clearance at this point is actually less than the diameter of the neck of the climbing stick attachment knob, thus creating a detent that will hold the attachment knob from shaking loose during transport;
the climbing stick attachment knob will be pushed down through the hole in the top surface of the treestand platform until the head of the knob passes through far enough to let the smaller diameter neck of the attachment knob line up with the top surface of the treestand platform;
once the climbing stick attachment knob is engaged in the larger hole the user would then pull on the climbing stick in the direction of the slot, thus forcing the climbing stick attachment knob's neck to pass by the detent and then be resting in the remaining portion of the slot;
the treestand platform can have multiple climbing stick attachment key hole shaped openings molded into its surface to allow for transport and storage of multiple climbing sticks.
